(19) United States
(12) Patent Application Publication
(10) Pub. No.: US 2018/0225422 A1
(43) Pub. Date: Aug. 9, 2018

(54) MEDICATION DISPENSING APPARATUS AND METHOD

(71) Applicant: Alexis Burt FELDMAN, Saylorsburg, PA (US)

(72) Inventor: Alexis Burt FELDMAN, Saylorsburg, PA (US)

(21) Appl. No.: 15/597,527

(22) Filed: May 17, 2017

Related U.S. Application Data
(60) Provisional application No. 62/499,679, filed on Feb. 3, 2017.

(51) Int. Cl. G06F 19/00; G07C 9/00

(52) U.S. Cl. CPC G06F 19/3462; G06F 19/3406; G07C 9/00158

(57) ABSTRACT

An apparatus for medication doses has a plurality of slots, each for storing a respective one of the medication doses, a plurality of doors, each for successively preventing and allowing access to a respective one of the plurality of slots, a plurality of locking mechanisms, each for locking a respective one of the doors relative to the respective one of the slots, and a processor for determining when predetermined, successive time periods have arrived, comparing received identification data with prestored personal data, and allowing each of the locking mechanisms to unlock based on said determining and said comparing. A method of dispensing medication doses enables medication doses to be dispensed from locked slots that are successively unlocked on a timed basis.

This application claims priority under 35 USC § 119 to U.S. Provisional Application 62/499,679 filed on Feb. 3, 2017, which is hereby incorporated by reference in its entirety.

### FIELD OF THE INVENTION

The present invention relates to medication dispensing and more particularly to medication dispensing on an individual dosage basis. Specifically, an apparatus and method are disclosed for dispensing medication dosages at specific time periods after receiving identification data.

### BACKGROUND OF THE INVENTION

According to the U.S. Department of Health and Human Services (HHS), more people died from drug overdoses in 2014 than in any year on record prior. More than 60% of those deaths involved an opioid. Since 1999, 165,000 people have died from prescription opioid overdoses. Each year, $55 billion in health and social costs are related to prescription opioid abuse. Furthermore, there has been a $20 billion economic impact from the opioid epidemic with regard to emergency departments and inpatient care.

The U.S. Department of Health and Human Services has provided other statistics as well. On an average day in the United States, 3900 people initiate nonmedical use of prescription opioids. Furthermore, on an average day in the United States, 78 people die from an opioid—related overdose.

The U.S. Department of Health and Human Services has acknowledged that prevention, treatment, research, and effective responses to quickly reverse opioid overdoses are critical to fighting the opioid epidemic.

Opioid use has been known to lead to heroin use. On an average day in the United States, 580 people initiate heroin use. It is also known that, over the past few years, there has been an increase in deaths involving synthetic opioids such as fentanyl.

Part of the reason why opioid use has become so widespread is because the drug is so freely available.

### SUMMARY OF THE INVENTION

An apparatus for dispensing medication doses has a plurality of slots, each for storing a respective one of the medication doses, a plurality of doors, each for successively preventing and allowing access to a respective one of the plurality of slots, a plurality of locking mechanisms, each for locking a respective one of the doors relative to the respective one of the slots, and a processor for determining when predetermined, successive time periods have arrived, comparing received identification data with prestored personal data, and allowing each of said locking mechanisms to unlock based on the determining and the comparing. A method of dispensing medication doses enables medication doses to be dispensed from locked slots that are successively unlocked on a timed basis.

### BRIEF DESCRIPTION OF THE DRAWINGS

FIG. 1 is a perspective drawing of a medication container in accordance with a first exemplary embodiment of the present invention.

FIG. 2 is a front view of several slots and associated doors for the medication container shown in FIG. 1.

FIG. 3A and FIG. 3B are two interior views of the door shown in FIG. 2. In FIG. 3A, an exemplary door is shown in an unlocked state. In FIG. 3B, an exemplary door is shown in a locked state.

FIG. 4 is a front view of a user interface in accordance with an exemplary embodiment of the present invention.

FIG. 5 is a cutaway view which further shows the door and locking mechanism illustrated by FIG. 3A and FIG. 3B.

FIG. 6 is a block diagram of a microcontroller, motor drivers, and actuators that are used in combination with a plurality of door shown in FIG. 1.

FIG. 7 is a flowchart diagram that illustrates an exemplary method for practicing the present invention.

FIG. 8 is a virtual image of a graphic user interface that may be used to program the opening sequence for the medication container in accordance with an exemplary embodiment of the present invention.

### DETAILED DESCRIPTION

Opioid usage in the United States is clearly at epidemic levels. The Federal Government, state governments, healthcare providers, law enforcement, and others have been taking many steps in order to try to curb dangerous opioid use. One such step has been to provide information to the public, with the hopes that by providing education, harmful opioid use will decrease. For example, information packets are available from various sources, including pharmacies, in order to provide helpful information. Some of this information includes where an opioid abuser can get help. Unfortunately, drug overdose deaths are at record levels. Thus, further solutions to the opioid epidemic would be desirable. One possible solution to the opioid epidemic is to control access to opioids.

In an exemplary embodiment of the present invention, an apparatus is useful for controlling the dispensing of medication. The apparatus includes multiple slots, and each slot includes its own respective locking door. Prior to patient use, a dosage of medication is inserted into each slot and access to all slots is then prevented by actuating locks on their respective doors. Inserting the medication into the slots and locking the doors can be performed, for example, by a medical provider such as a pharmacist. After all of the doors corresponding to slots storing medication have been locked, the apparatus may then be made available to the patient. All (or many) of the locks may be electronically controlled so that each door is unlocked at respectively different predetermined intervals (for example, once a day). In this manner, the patient only has access to one medical dose per day.

This apparatus and associated method provides numerous advantages over the prior art. For example, as a result of this apparatus and/or associated method, medication overdose risk may be decreased, because the patient is only able to obtain access to limited amounts of medication at a time. Furthermore, because the medication is available at predetermined times, and after the patient completes a certain security procedure(s), unauthorized people are prevented from obtaining access to the medication. This feature may help to prevent the patient from voluntarily giving the medication to someone other than the patient. This procedure may also help to prevent the medication from being stolen.

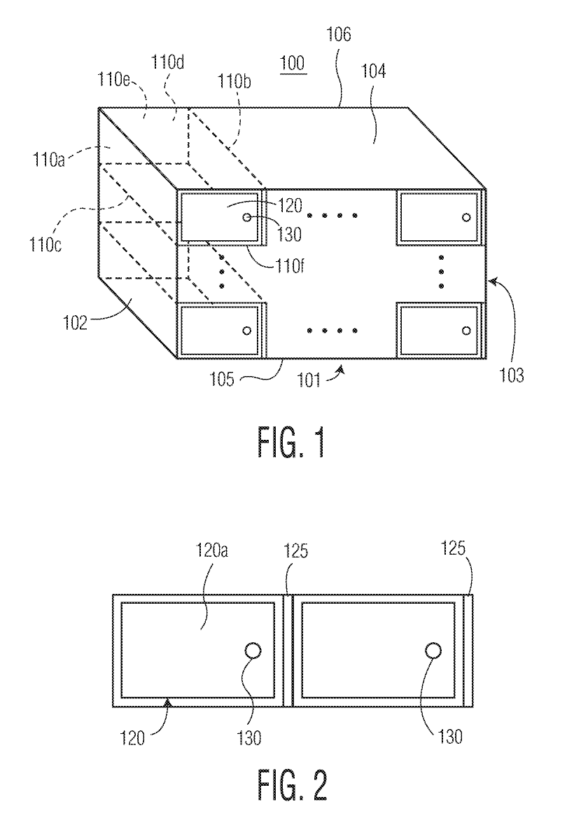

An exemplary embodiment of the present invention is illustrated in FIG. 1 in which a perspective view of medication container 100 is shown. Medication container 100 is comprised of a material of sufficient strength to deter a patient from breaking into medication container 100 and removing medication stored therein. Exemplary materials that may be used for medication container 100 include strong resins, forged aluminum, carbon fiber, Kevlar, or other materials of sufficient structural integrity. Medication container 100 includes container top 104, container bottom 105, container side 102 (shown on the left side of the figure), container side 103 (shown on the right side of the figure) and container rear 106.

Container 100 is comprised of a plurality of slots. Again, the slots may be formed using materials of sufficient strength so that once a patient has access to one slot, access to an adjacent slot through a shared wall is deterred. FIG. 1 shows that these slots are arranged in rows and columns. However, this configuration is merely exemplary. Furthermore, the number of rows and the number of columns of slots may vary based on the total number of doses of medication that a medical provider wishes to provide to a patient (e.g. if a medical provider wishes to provide five dose of medication, then five slots may be used). In one exemplary embodiment, container 100 includes at least 31 slots to accommodate one month's worth of medication (assuming one dose is taken daily). Thus, while FIG. 1 shows a minimum of four slots, it is understood that the total number of slots included may be more than what is shown, and there may be a different number of rows and/or columns. Also, while multiple rows and columns are shown, the invention may be implemented with a single row or a single column. As shown in FIG. 1, each slot is comprised of slot side 110a, opposing slot side 110b, slot top 110d, and slot bottom 110c. The various walls that form one slot may be shared with another slot. Thus, for example, from the perspective shown in FIG. 1, while the slot in the upper left-hand corner includes slot side 110b on a right side thereof, slot side 110b may be the leftmost slot side of a slot immediately to the right of the slot shown in the upper left-hand corner. Furthermore, while the slot in the upper left-hand corner includes slot bottom 110c, slot bottom 110c may also define the top of a slot directly below the slot shown in the upper left-hand corner. Each slot includes slot rear 110d which may be comprised of container rear 106. An exemplary dimension for each slot may be fifteen inches long, two inches high, and one inch wide, but again, this is merely exemplary. While the word “walls” has been used, it is understood that slot tops, bottoms and sides may simply be structures that keep each medicine dose separated from each other in their respective slots.

FIG. 1 illustrates that each slot 110 includes a respective door 120. While doors are shown in FIG. 1, this is merely exemplary as the intent is to provide any mechanism that prevents access to the contents of each slot 110. Door 120 includes handle 130 which is used to open door 120. As shown in FIG. 1, each slot includes its respective door 120 which may be included in the configuration shown in FIG. 1, although this is merely exemplary.

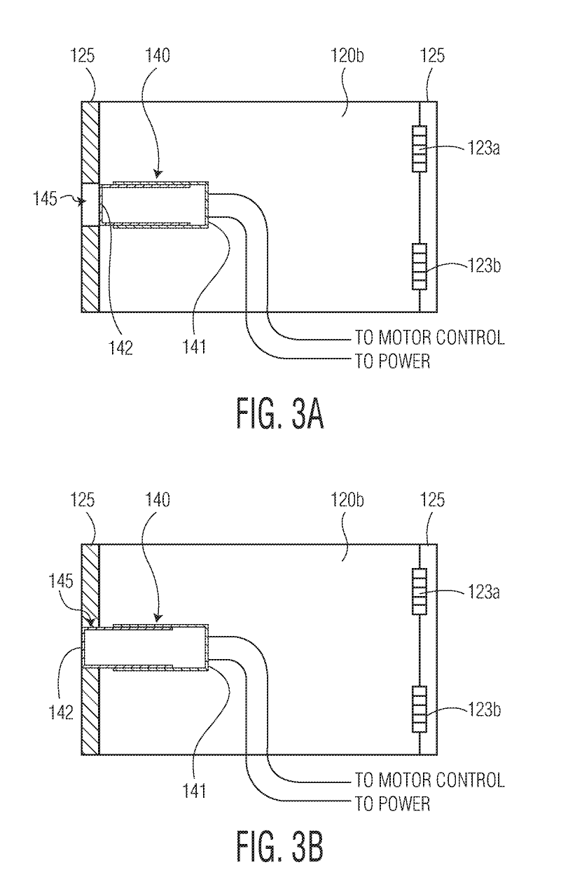

FIG. 2 is a further illustration of an exemplary front for medication container 100. FIG. 2 illustrates a plurality of exemplary slots which are situated adjacent to each other and which each include respective door 120. Each door 120 is opened with respective handle 130. FIG. 2 illustrates that between adjacent doors, spacer 125 may be included. Spacer 125 may be used, for example, as part of the mechanism that allows each door 120 to be locked. The locking mechanism for each door 120 is further illustrated in FIG. 3A and FIG. 3B. As FIG. 2 illustrates an exemplary front for medication container 100, FIG. 2 illustrates door front 120a which faces outwards towards a patient that wishes to withdraw medication from a slot 110. Thus, for example, after optional security features have been satisfied, a patient is able to pull on handle 130 in order to open door 120 so that the interior of slot 110 is exposed and access to medication stored in slot 110 is available.

FIG. 3A and FIG. 3B illustrate operation of door 120. While the perspective of FIG. 2 is from directly in front of medication container 100, and looking towards door front 120a, the perspective of FIGS. 3A and 3B is from inside slot 110 and looking towards door rear 120b. Thus, FIG. 3A and FIG. 3B illustrate door 120 as viewed from the opposite direction relative to the view that appears in FIG. 2. In FIG. 3B, door 120b is able to open and close by pivoting about hinge 123a and hinge 123b. Locking mechanism 140 is included. Locking mechanism 140 may be, for example, an electronic linear actuator. An electronic linear actuator includes shaft 142 and linear actuator 141. Linear actuator 141 may be coupled to power and motor control (although in some embodiments, power and motor control are accomplished using the same electric connections). While hinges 123a and 123b are shown on the right side of door rear 120b, spacer 125 is shown on the left side of door rear 120b. Spacer 125 includes latch 145. Latch 145 is engaged by shaft 142. When shaft 142 engages latch 145, door 120 is locked and cannot be opened.

In FIG. 3B, shaft 142 has been actuated so that it extends into latch 145. Again, shaft 142 has been actuated as a result of operation of electric linear actuator 141. In FIG. 3A, shaft 142 is not actuated and therefore door 120 may be opened. By contrast, in FIG. 3B, shaft 142 has been actuated so that shaft 142 extends into latch 145 and door 120 is prevented from being opened.

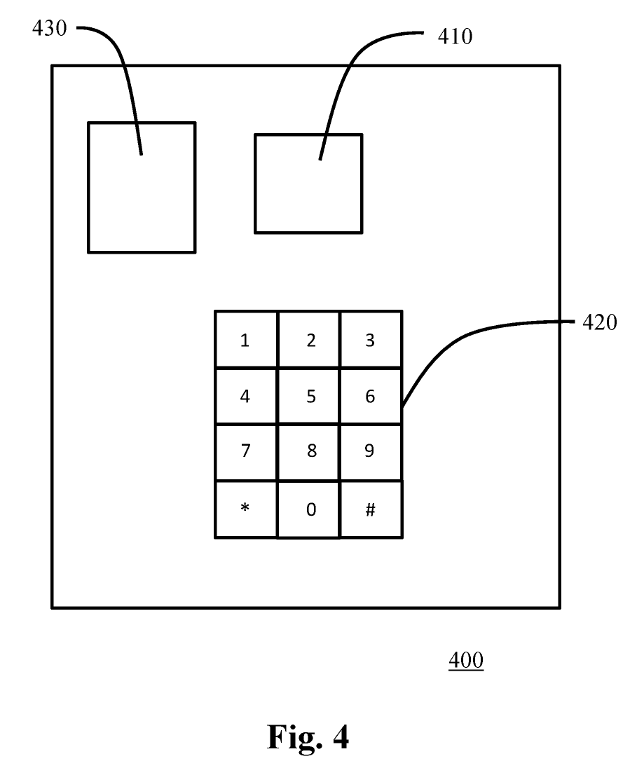

Thus, actuation of shaft 142 in FIG. 3A and FIG. 3B results in door 120 being locked and unlocked. The process of locking and unlocking door 120 is part of the security features of medication container 100. However, there may also be further optional security features. It is the combination of all of the security features which controls which door 120 is locked, which door 120 is unlocked, and when each door 120 is locked or unlocked. In one exemplary embodiment, when cabinet 100 is given to a patient, with all desired slots filled with medication, all doors 120 in medication container 100 are initially in a locked state. Then, over time, each door 120 is successively opened at a respectively appropriate time (and/or day). For example, each door 120 may be opened on a respectively different day. There may be, however, other mechanisms which determine whether and when each door is in a locked or an unlocked state. FIG. 4 illustrates one such security mechanism.

FIG. 4 includes user interface 400 which includes optional user interface features that are used to determine when to unlock each door 120. Thus, user interface 400 is providing optional security features so that doors are not unlocked until these security features have been satisfied. Input via user interface 400 may detected on an interrupt basis, or user interface 400 may be periodically evaluated to determine if at any given time a user is using user interface 400. In the exemplary embodiment shown in FIG. 4, user interface 400 includes a biometric scanner 410. One exemplary biometric scanner may be a fingerprint or a thumbprint reader. An exemplary fingerprint scanner is the Lumidigm M301 Multispectral Fingerprint Scanner. Other biometric scanners may include voice recognition, iris recognition, retinal recognition, etc. and all these forms of biometric scanning are merely exemplary. In an alternative embodiment of the present invention, keypad 420 is included. Thus, keypad 420 may operate like a digital lock so that entering a secret code into keypad 420 causes a respective door to unlock depending upon time, day, etc. Data entered via user interface 400 may be referred to as identification data, and received identification data is compared with prestored personal data (again corresponding to biometrics, a secret code, etc.) to confirm that the user providing the data should be provided access to cabinet 100 by unlocking one or more doors.

In a further exemplary embodiment the present invention, user interface 400 includes wireless adapter 430. Wireless adapter 430 is able to receive security data from a wireless device such as a cell phone or tablet. Communication between wireless adapter 430 and a wireless device may be performed using a wireless communication protocol, of which cellular, Wi-Fi, Bluetooth, and NFC are merely examples. Thus, the wireless device may include a keypad which, upon receipt of an expected secret code transmits a signal to wireless adapter 430. Alternatively, the wireless device may include its own form of biometric scanning, again, fingerprint detection, iris detection, etc. so that upon identification of expected biometrics, appropriate signals are transmitted to wireless adapter 430. In a further embodiment, the wireless device can scan an object such as a bar code or QR code, and upon scanning an acceptable object, transmit a security signal (i.e. an expected signal) to wireless adapter 430 so that a door 120 may be unlocked. Once wireless adapter 430 receives an expected signal, or upon receipt of expected data by biometric scanner 410 or keypad 420, a signal is transmitted to a microprocessor (e.g. microcontroller 600) indicating that access to a slot 110 has been authorized. Then, depending upon timing information (such as day, time of day, etc.) the microprocessor (described below) can transmit an appropriate signal so that an appropriate door 120 is unlocked.

In one exemplary embodiment, authentication to determine whether security requirements have been met to unlock a door 120 is accomplished in the wireless device described above. In another exemplary embodiment, authentication to determine whether security requirements have been met to unlock a door 120 is accomplished in a microprocessor (e.g. microcontroller 600) as explained below.

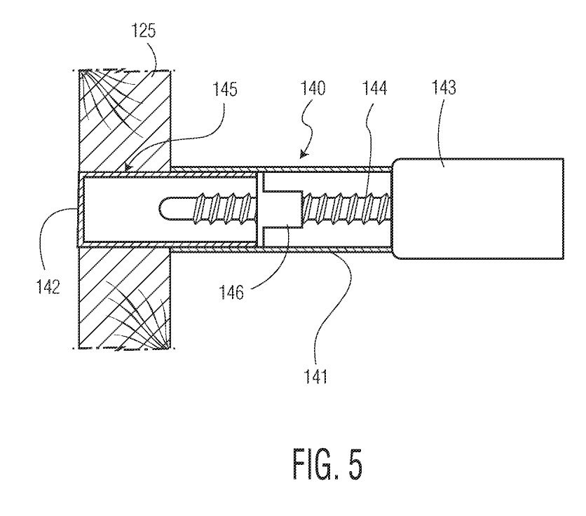

FIG. 5 is a further perspective drawing which illustrates the operation of locking mechanism 140. Shaft 142 engages latch 145 in spacer 125 in order to lock door 120. Motor (e.g. stepper motor 143) is under the control of microcontroller 600. Stepper motor causes threaded member 144 to rotate, causing nut member 146 to move along threaded member 144. Nut member 146 is attached to shaft 142. As motor 143 rotates threaded member 144 in one direction, shaft 142 engages latch 145. As motor 143 rotates threaded member 144 in the opposite direction, shaft 142 disengages from latch 145. Engaging latch 145 causes door 120 to lock. Disengaging latch 145 causes door 120 to unlock.

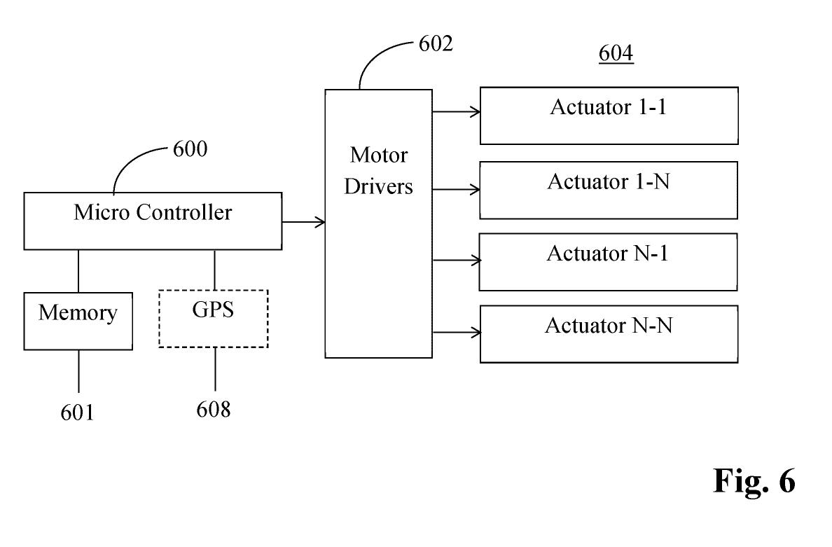

FIG. 6 is a block diagram which illustrates exemplary operation of microcontroller 600. Microcontroller 600 serves several functions.

One exemplary function of microcontroller 600 is to keep track of what day (and/or time) it is. In this exemplary embodiment, a respectively different door 120 is unlocked each day (for example) so that access to a respectively different slot 110 may be obtained. Assume, for example, that a patient has been directed to use medication (opioids) over four successive days. FIG. 2 illustrates an exemplary embodiment of the present invention in which four adjacent doors 120 are included, each door preventing access to a respective slot 110. In this example, the patient's medication for Monday is stored behind door 1201, the patient's medication for Tuesday is stored behind door 1202, the patient's medication for Wednesday is stored behind door 1203, and the patient's medication for Thursday is stored behind door 1204. In this exemplary embodiment, microcontroller 600 controls access to each of the doors 120 shown in FIG. 2.

In this exemplary embodiment, microcontroller 600 keeps track of which day of the week it is. In one example, microcontroller 600 may enable a respective door to be unlocked at a certain time each day, for example 12 noon. In one exemplary embodiment, microcontroller 600 will unlock a door based only on time, i.e. what day of the week it is and/or whether one or more doors are to be opened at respective times on each day. In another exemplary embodiment, microcontroller 600 will open each door based on a certain time (and/or day) being reached and based on whether identification data is received. In one exemplary embodiment, identification data is received from one of the user interface examples that is illustrated with regard to user interface 400. One preferable example of the use of user interface 400 in combination with microcontroller 600 is with regard to fingerprint identification. Assume that biometric scanner 410 is for identifying fingerprints (such as a thumbprint). User interface 400 thus will have pre-stored therein data corresponding to a thumbprint of the patient that is authorized to remove medication from cabinet 100. When the patient places their finger (e.g. thumb) against biometric scanner 410, a scan of the patient's finger is taken and then is compared with prestored data stored within user interface 400. If the prestored data and the data from the patient's fingerprint are match, then user interface 400 will signal microcontroller 600 that indeed a match has occurred. Thus, based on detection of the match and a predetermined time and/or day being reached, microcontroller 600 will transmit a signal so that one of the doors 120 is unlocked. Again, as an example, door 1201 may be unlocked on Monday, door 1202 may be unlocked on Tuesday, door 1203 will be unlocked on Wednesday, and door 1204 will be unlocked on Thursday.

Memory 601 is also included. Memory 601 may include software to operate microcontroller 600 (if microcontroller 600 does not have onboard software storage). Memory 601 may also include other data, such as timing for unlocking each door 120 (as explained below), optional GPS data (also explained below) etc. As shown, memory 601 is coupled to microcontroller 600 so that memory 601 and microcontroller 600 may communicate with each other.

Once microcontroller 600 determines that a door should be unlocked, a locked door is unlocked. This operation is performed when microcontroller 600 signals motor drivers 602. Motor drivers 602 then signals one of the actuator 604 based on the prestored information which indicates which of the doors should next be unlocked. The prestored information may simply be, for example, that each door has a respective identification number, the doors are opened in succession, and the next locked door in the succession is the one that is unlocked. The appropriate actuator is given an appropriate signal so that the appropriate door can be unlocked, and the door is unlocked. The patient is then able to open the appropriate door 120 by grasping handle 130 so that the door may pivot about its respective hinges. In this manner, the door can be opened so that the user is able to place his/her hand inside the respective slot. At that moment, any medication (opioids) in the slot of the door that has been opened can be removed.

The above explanation describes various operations performed by microcontroller 600. It is understood, however, that some or all of these operations may be performed by microprocessor based device (e.g. smartphone or tablet as described above) external to medication container 100.

In one exemplary embodiment, each door 120 is labeled with identification, such as a number, a calendar day, or the day of the week. In this manner a patient knows which door will be unlocked next.

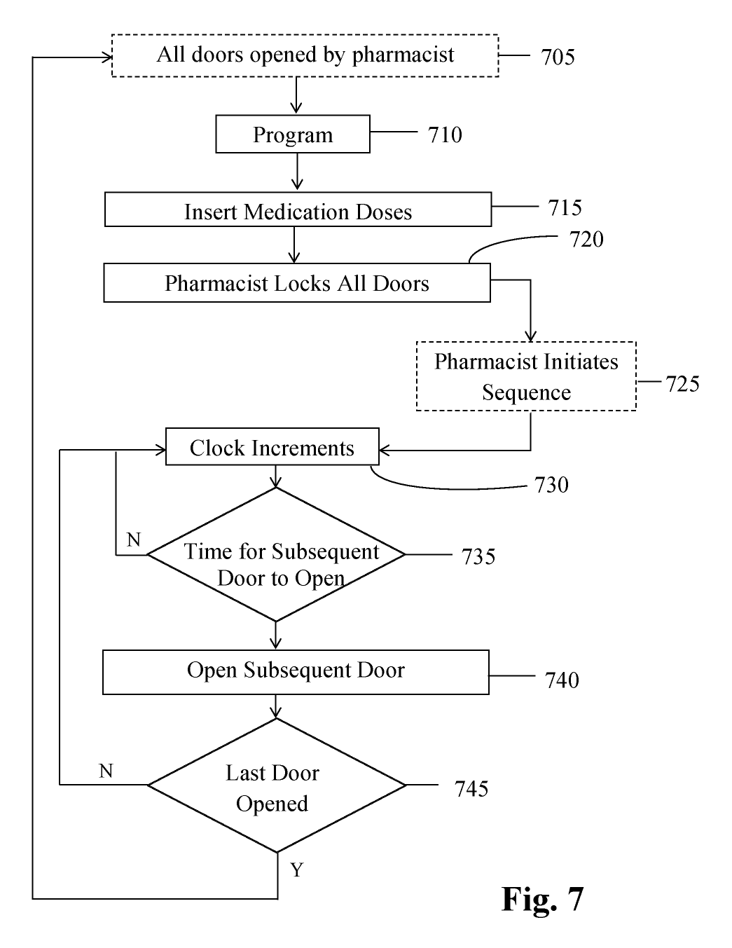

FIG. 7 is a flowchart diagram which illustrates operation of an exemplary embodiment of the present invention. Before medication container 100, filled with the medication, can be given can receive patient access, the medication needs to be loaded into medication container 100. The loading of medication into medication container 100 may be done, for example, by a pharmacist. In order to perform that operation, the doors of all slots that will hold medication need to be unlocked. If any of the doors of slots that will be holding medication are locked, then, as a first step, the doors of all slots that will be holding medication are desirably unlocked. This procedure may be performed through optional step 705. Thus, for example at step 705, the pharmacist enters security data into user interface 400 (independent of the prestored personal data corresponding to a patient—e.g. biometric data). The security data that is entered by, for example, a pharmacist is independent of the prestored personal data that is compared with the received identification data that is received when a patient desires access to one of the doors in the medication container 100.

Thus, again, if any doors 120 of medication container 100 are locked, those doors may need to be unlocked so that the pharmacist can insert medication into the respective slot. Thus, the pharmacist enters security data into user interface 400. User interface 400, upon receipt of the security data, signals microcontroller 600, microcontroller 600 signals motor drivers 602, and motor drivers 602 subsequently signal the actuators 604 of all doors to actuate in a manner so that all doors are unlocked.

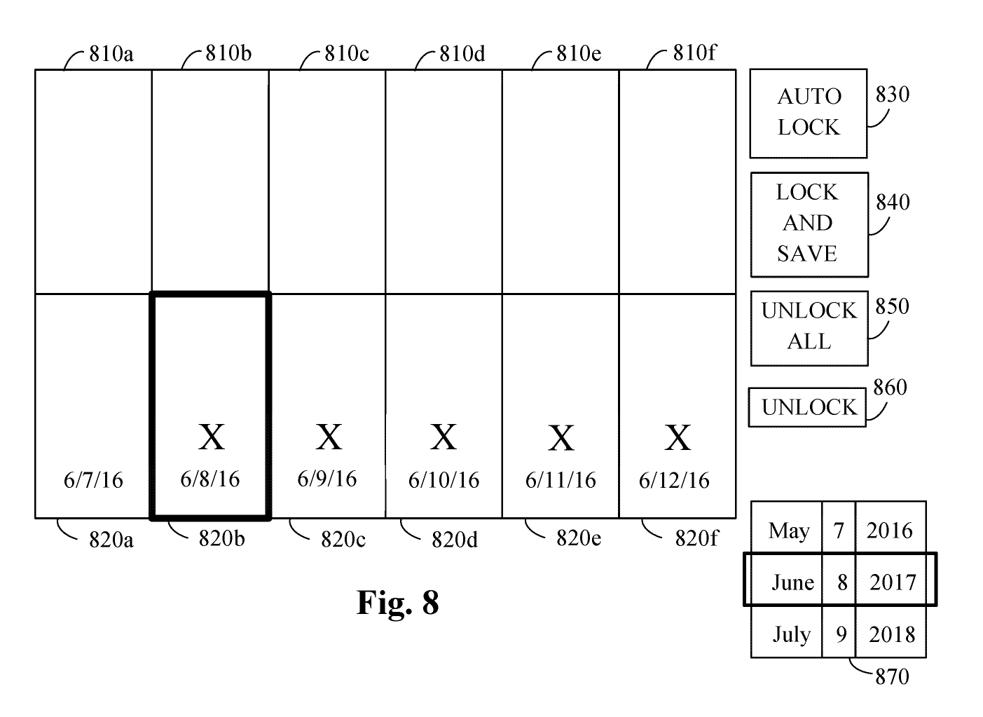

At step 710, the pharmacist programs medication container 100 as to which slots will be locked, and when each slot will be unlocked. Programming may be accomplished using, for example, a user interface. The user interface may be included with user interface 400 or the user interface may be located on an external device, such as a smart phone, tablet, or personal computer as described above. On any of those devices, for example, images corresponding to all of the doors 120 included with medication container 100 may appear. The images may be, for example, virtual images. This is illustrated in FIG. 8 in which an example of a virtual image of the doors of an exemplary medication container 100 appears. The exemplary container includes two rows, each with six doors.

In the exemplary user interface shown in FIG. 8, a door is indicated as being unlocked by being completely white, and a door is indicated as being locked by displaying a large “X” therein. As shown, a plurality of graphical devices enable locking, unlocking, and programming.

For example, a pharmacist may touch the image of a specific door in order to program that door. In the example, image 820b has been touched so that a door corresponding to image 820b may be programmed. Image 820b may be highlighted to indicate that it is in the process of being programmed. If a pharmacist wants to program the door corresponding to image 820b to unlock on Jun. 8, 2017, the following steps may take place:
1) Pharmacist touches image 820b and outline of image 820b appears.
2) Pharmacist scrolls virtual scrollwheel 870 until “Jun. 8, 2017” appears.
3) Pharmacist touches “LOCK AND SAVE” icon 840 so that the door corresponding to image 820 b is locked.
4) Door corresponding to image 820b will unlock on Jun. 8, 2017 (after other security features are satisfied, a certain time of day is reached, etc.).

Optional UNLOCK ALL icon 850 is also included. When touched, all doors will be unlocked.

Optional AUTO LOCK icon 830 is included. When touched, all doors are locked, and each door is unlocked on a respectively successive day after the day all of the doors are locked (in combination with any other security features).

Optional UNLOCK icon 860 is included. When an image corresponding to a door has been touched (and subsequently, the image is highlighted), touching UNLOCK icon 860 causes that door corresponding to that image to be unlocked. Upon being unlocked, the “X” is removed from that image.

As shown, once locked, the image of the respective door that has been locked displays the day when the door will unlock (when accompanied by additional security features, if required).

The description above is with regard to programming a day when a door will be unlocked. Optional features may be included to specify a time when a door will be unlocked.

The user interface shown in FIG. 8 is merely an example of how door opening may be programmed. Other user interfaces may be used as well.

At step 715, the pharmacist places medication in all slots that are to be locked.

At step 720, after all medication doses have been inserted into their respective slots, the pharmacist locks all desired doors on medication container 100 as explained above. Slots may be locked one at a time in succession or optionally simultaneously.

Next is the issue of when doors are to be unlocked once medication container 100 is accessible to a patient. The unlocking sequence may default to a predefined procedure. The predefined procedure may be, for example, beginning the day after the day that the pharmacist locks the doors, once a day, at a preset time (for example noon) a door 120 is unlocked (assuming other security requirements, e.g. biometrics, password, etc., are met). On every subsequent day, another door is unlocked (again assuming other security requirements have been met).

Note that step 725 is optional if the default opening sequences to be used.

Once the LOCK AND SAVE button has been pressed, an internal clock within microprocessor 600 begins to increment (or continues to increment) in order to keep track of day and time. Either as a result of the default programming or the custom programming at step 725, microprocessor 600 has stored therein the time when a next one of the doors is to be unlocked (after other security requirements, if any, have been met). As the internal clock within microprocessor 600 is counting upwards, the data time stored within microprocessor 600 is compared with the prestored day in time when a next door is to be unlocked. This comparison takes place at step 735. If the comparison indicates that it is not yet time for the door to be unlocked, processing proceeds back to step 730. However, at step 735, if it is determined that the date and time of when the door is to be unlocked has been reached, then, at step 740, the door is allowed to be open (if other security requirements have been met).

At step 745 it is determined whether all doors 120 that have been programmed by the pharmacist have been opened. If all doors 120 that were supposed to be open have indeed been opened, then processing proceeds back to optional step 705.

In a further exemplary embodiment of the present invention, optional GPS receiver 608 is included. GPS receiver 608 is coupled to microcontroller 600 so that GPS receiver 608 and microcontroller 600 may communicate. GPS receiver 608 is able to determine, using GPS data, where medication container 100 is located. In one example, it may be expected that medication container 100 is in two places, namely with a pharmacist (for example) so that medication doses can be loaded into medication container 100, and at the residence of the patient that is taking the medication doses. The use of GPS receiver 608 enables detection that medication container 100 has been at another location (e.g. an unapproved location) for possible forcible entry into medication container 100 and/or possible theft of unapproved dispensing (to the patient and/or to an individual who is not a patient for which the medication stored in medication container 100 is intended). GPS receiver 608 can periodically transmit GPS data to microcontroller 600, for subsequent storage of GPS data into memory 601. At any time (for example, when medication container is being reloaded with medication), the contents of memory 601 can be retrieved and viewed to identify where medication container 100 has been. Such retrieval may be through the user interface illustrated for example in FIG. 7.

GPS receiver 608 may be implemented with any off-the-shelf GPS receiver. GP-735 manufactured by ADH Technology is an exemplary receiver and may be implemented with details as set forth in GPS-735 Datasheet 1.0 (ADH Technology) which is hereby incorporated by reference in its entirety.

Powering the electronics described above with regard to medication container 100 may be via standard wall voltage (110V-120V in the United States) and one or more step down transformers to power the actuators and microelectronics. 12V is an exemplary voltage to power the actuators. 5V may be adequate. The microelectronics may be powered with 5V. A backup rechargeable battery (5V, 12V or combination) may be included to provide portable operation of medication container 100 or in case of power failure.

In an exemplary embodiment of the present invention a computer system may be included and/or operated within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system includes a processing device, a main memory (e.g., read-only memory (ROM), flash memory, dynamic random access memory (DRAM) (such as synchronous DRAM (SDRAM) or Rambus DRAM (RDRAM), etc.), a static memory (e.g., flash memory, static random access memory (SRAM), etc.), and a data storage device, which communicate with each other via a bus.

Processing device represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device may also be one or more special-purpose processing devices such as an application specific integrated circuit (ASIC), a field programmable gate array (FPGA), a digital signal processor (DSP), network processor, or the like. Processing device is configured to execute listings manager logic for performing the operations and steps discussed herein.

Computer system may further include a network interface device. Computer system also may include a video display unit (e.g., a liquid crystal display (LCD) or a cathode ray tube (CRT)), an alphanumeric input device (e.g., a keyboard), a cursor control device (e.g., a mouse), and a signal generation device (e.g., a speaker).

Data storage device may include a machine-readable storage medium (or more specifically a computer-readable storage medium) having one or more sets of instructions (e.g., reference generation module) embodying any one or more of the methodologies of functions described herein. The reference generation module may also reside, completely or at least partially, within main memory and/or within processing device during execution thereof by computer system; main memory and processing device also constituting machine-readable storage media. The reference generation module may further be transmitted or received over a network via network interface device.

Machine-readable storage medium may also be used to store the device queue manager logic persistently. While a non-transitory machine-readable storage medium is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instruction for execution by the machine and that causes the machine to perform any one or more of the methodologies of the present invention. The term “machine-readable storage medium” shall accordingly be taken to include, but not be limited to, solid-state memories, and optical and magnetic media.

The components and other features described herein can be implemented as discrete hardware components or integrated in the functionality of hardware components such as ASICs, FPGAs, DSPs or similar devices. In addition, these components can be implemented as firmware or functional circuitry within hardware devices. Further, these components can be implemented in any combination of hardware devices and software components.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the aforementioned description, numerous details are set forth. It will be apparent, however, to one skilled in the art, that the disclosure may be practiced without these specific details. In some instances, well-known structures and devices are shown in block diagram form, rather than in detail, in order to avoid obscuring the disclosure.

The disclosure is related to an apparatus for performing the operations herein. This apparatus may be specially constructed for the required purposes or it may comprise a general purpose computing device selectively activated or reconfigured by a computer program stored therein. Such a computer program may be stored in a non-transitory computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions, each of which may be coupled to a computer system bus.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

### PARTS LIST

100 Medication container
101 Container front
102 Container side
103 Container side
104 Container top
105 Container bottom
106 Container rear
110 Slot
110a Slot side
110b Slot side
110c Slot Bottom
110d Slot top
110e Slot rear
110f Slot front
120 Door
120a Door Front
120b Door rear
123a Hinge
123b Hinge
125 Spacer
130 Handle
140 Locking mechanisms
141 Linear Actuator
142 Shaft
145 Latch
400 User interface
410 Biometric scanner
420 Key pad
600 Microcontroller
601 Memory
602 Motor Drivers
604 Actuators
608 GPS receiver

1. Apparatus for dispensing medication doses, said apparatus comprising:
a plurality of slots, each for storing a respective one of said medication doses;
a plurality of doors, each for successively preventing and allowing access to a respective one of said plurality of slots;
a plurality of locking mechanisms, each for locking a respective one of said doors relative to said respective one of said slots;
a processor for:
determining when predetermined, successive time periods have arrived,
comparing received identification data with prestored personal data, and
allowing each of said locking mechanisms to unlock based on said determining and said comparing.

2. Apparatus according to claim 1, wherein said identification data is biometric data obtained from a person's body.

3. Apparatus according to claim 1, wherein said identification data is alphanumeric data.

4. Apparatus according to claim 1, wherein said locking mechanisms each include a mechanical lock, when locked said mechanical lock is prevented from being unlocked, when unlocked said mechanical lock is permitted to be unlocked responsive to receipt of external force applied to said lock.

5. Apparatus according to claim 1, wherein said slots are located in a plurality of adjacent rows and columns.

6. Apparatus according to claim 1, wherein said predetermined successive time slots are initiated based on when said locking mechanisms are locked.

7. Apparatus according to claim 1, wherein said predetermined successive times slots are initiated independently of when said locking mechanisms are locked.

8. Apparatus according to claim 1, wherein receipt of security data independent of said prestored personal data and said successive time periods operates all of said locking mechanisms.

9. Apparatus according to claim 1, wherein not more than once in a day a different respective one of said lock mechanisms is unlocked.

10. Apparatus according to claim 1, wherein said locked slots include medication doses and said unlocked slots are empty.

11. Apparatus according to claim 1, further comprising a GPS receiver for obtaining GPS location data of said apparatus.

12. A method of dispensing medication doses, said method comprising the steps of:
a) providing a plurality of slots, each for storing a respective one of said medication doses;
b) providing a plurality of doors, each for successively preventing and allowing access to a respective one of said plurality of slots;
c) providing a plurality of locking mechanisms, each for locking a respective one of said doors relative to said respective one of said slots;
d) determining when predetermined, successive time periods have arrived,
e) comparing received identification data with prestored personal data, and
f) allowing each of said locking mechanisms to unlock based on said determining and said comparing.

13. A method of dispensing medication doses according to claim 12, wherein said identification data is biometric data obtained from a person's body.

14. A method of dispensing medication doses according to claim 12, wherein said identification data is alphanumeric data.

15. A method of dispensing medication doses according to claim 12, wherein said locking mechanisms each include a mechanical lock, when locked said mechanical lock is prevented from being unlocked, when unlocked said mechanical lock is permitted to be unlocked responsive to receipt of external force applied to said lock.

16. A method of dispensing medication doses according to claim 12, wherein said slots are located in a plurality of adjacent rows and columns.

17. A method of dispensing medication doses according to claim 12, wherein said predetermined successive time slots are initiated based on when said locking mechanisms are locked.

18. A method of dispensing medication doses according to claim 12, wherein said predetermined successive times slots are initiated independently of when said locking mechanisms are locked.

19. A method of dispensing medication doses according to claim 12, wherein receipt of security data independent of said prestored personal data and said successive time periods operates all of said locking mechanisms.

20. A method of dispensing medication doses according to claim 12, wherein not more than once in a day a different respective one of said locking mechanisms is unlocked.

21. A method of dispensing medication doses according to claim 12, wherein said locked slots include medication doses and said unlocked slots are empty.

22. A method of dispensing medication doses according to claim 12, further comprising the step of obtaining GPS location data of said plurality of slots.
